(19) United States
(12) Patent Application Publication
(10) Pub. No.: US 2021/0256073 A1
(43) Pub. Date: Aug. 19, 2021

(54) EDGE SYSTEM, INFORMATION PROCESSING METHOD AND COMPUTER READABLE MEDIUM

(71) Applicant: MITSUBISHI ELECTRIC CORPORATION, Tokyo (JP)

(72) Inventors: Ikumi MORI, Tokyo (JP); Genya ITAGAKI, Tokyo (JP)

(73) Assignee: MITSUBISHI ELECTRIC CORPORATION, Tokyo (JP)

(21) Appl. No.: 17/308,591

(22) Filed: May 5, 2021

Related U.S. Application Data
(63) Continuation of application No. PCT/JP2018/048071, filed on Dec. 27, 2018.

(51) Int. Cl. G06F 16/903; G06F 16/9032; G16Y 40/10; G16Y 40/35; H04L 29/08

(52) U.S. Cl. CPC G06F 16/90348; G06F 16/9032; H04L 67/10; G16Y 40/35; G16Y 40/10

(57) ABSTRACT

A response depth control unit (104) acquires response depth which is a request for depth of a search by a semantic engine (105). Further, the response depth control unit (104) causes the semantic engine (105) to repeat the search until the depth of the search by the semantic engine (105) reaches the response depth.

### CROSS REFERENCE TO RELATED APPLICATIONS

This application is a Continuation of PCT International Application No. PCT/JP2018/048071, filed on Dec. 27, 2018, which is hereby expressly incorporated by reference into the present application.

### TECHNICAL FIELD

The present invention relates to IoT (Internet of Things).

### BACKGROUND ART

In IoT, there is a case where a plurality of application programs (hereinafter, also simply referred to as applications) over a plurality of domains share information on various types of things (sensors) accumulated as big data on a cloud system (hereinafter, also simply referred to as cloud). In this case, it is desirable that an application can use without paying attention to domain knowledge of the sensor (an installation location, a type of data to be collected, accuracy, and the like).

oneM2M which is a standardizing body regrading IoT has worked on a standardization of a horizontally integrated type IoT platform that accepts a semantic query from an application and responds to the query (for example, Patent Literature 1). The horizontally integrated type IoT platform manages sensor data annotated by using ontology. Further, in the horizontally integrated type IoT platform, a response to the semantic query from the application is realized by an inference device. This allows the application to use the data without the domain knowledge of the sensor.

Further, a technique is also suggested in which metadata is added to a sensor side and an application side, pieces of metadata are matched with each other by using ontology, and a candidate for a sensor that can provide sensor data that satisfies a requirement for the application is extracted (for example, Patent Literature 2).

### CITATION LIST

### Patent Literature

Patent Literature 1: JP2018-503905A

Patent Literature 2: JP2018-81377A

### SUMMARY OF INVENTION

### Technical Problem

A conventional horizontally integrated type IoT platform is assumed to perform processing intensively on the cloud. Therefore, if the number of applications using the horizontally integrated type IoT platform increases significantly, there is a risk that a processing load may increase and response performance deteriorates. Even in a case where scaling up or scaling out is employed, the application is required to bear a cost evenly. Further, performing processing intensively on the cloud causes a communication delay, therefore, a requirement from the application that cannot accept the communication delay may not be satisfied.

An edge system is also assumed to be used to reduce load concentration on the cloud and solve the communication delay. However, a computational resource and a storage capacity of the edge system are limited. Therefore, it is necessary to appropriately respond to the query from the application by using the limited computational resource and storage capacity of the edge system.

The present invention is made in consideration of such circumstances. More specifically, the present invention mainly aims to enable an edge system to appropriately respond to a query from an application in a horizontally integrated type IoT platform.

### Solution to Problem

An edge system according to the present invention, corresponding to a horizontally integrated type IoT (Internet of Things) platform, includes:

a semantic engine;

a depth acquisition unit to acquire response depth which is a request for depth of a search by the semantic engine; and

a search control unit to cause the semantic engine to repeat the search until the depth of the search by the semantic engine reaches the response depth.

### Advantageous Effects of Invention

An edge system according to the present invention causes a semantic engine to repeat a search until depth of the search by the semantic engine reaches response depth. Therefore, the edge system can appropriately respond to a query from an application.

### BRIEF DESCRIPTION OF DRAWINGS

FIG. 1 is a diagram illustrating a configuration example of an IoT system according to a first embodiment;

FIG. 2 is a diagram illustrating a functional configuration example of an edge system according to the first embodiment;

FIG. 3 is a flowchart illustrating an operation example of the edge system according to the first embodiment;

FIG. 4 is a flowchart illustrating details of response depth determination process according to the first embodiment;

FIG. 5 is a diagram illustrating a configuration example of an IoT system according to a second embodiment;

FIG. 6 is a diagram illustrating functional configuration examples of an edge system (main system), an edge system (sub system), and a network storage according to the second embodiment;

FIG. 7 is a flowchart illustrating an operation example of the edge system (main system) according to the second embodiment;

FIG. 8 is a flowchart illustrating details of a semantic engine selection process according to the second embodiment;

FIG. 9 is a flowchart illustrating an operation example of the edge system (sub system) according to the second embodiment;

FIG. 10 is a diagram illustrating functional configuration examples of an edge system and a cloud system according to a third embodiment;

FIG. 11 is a diagram illustrating a functional configuration example of an edge system according to a fourth embodiment;

FIG. 12 is a flowchart illustrating an operation example of the edge system according to the fourth embodiment;

FIG. 13 is a flowchart illustrating details of a relevance determination process (query) according to the fourth embodiment;

FIG. 14 is a flowchart illustrating details of a relevance determination process (execution result) according to the fourth embodiment;

FIG. 15 is a diagram illustrating a functional configuration example of an edge system according to a fifth embodiment;

FIG. 16 is a flowchart illustrating an operation example of the edge system according to the fifth embodiment;

FIG. 17 is a flowchart illustrating details of a result expansion process according to the fifth embodiment;

FIG. 18 is a diagram illustrating functional configuration examples of an edge system and a cloud system according to a sixth embodiment;

FIG. 19 is a flowchart illustrating an operation example of the edge system according to the sixth embodiment;

FIG. 20 is a flowchart illustrating an operation example of the cloud system according to the sixth embodiment;

FIG. 21 is a diagram illustrating a functional configuration example of an edge system according to a seventh embodiment;

FIG. 22 is a diagram illustrating an example of Linked Data according to the seventh embodiment;

FIG. 23 is a diagram illustrating a depth specifying table according to the first embodiment; and

FIG. 24 is a diagram illustrating an endpoint specifying table according to the second embodiment.

### DESCRIPTION OF EMBODIMENTS

Hereinafter, embodiments of the present invention will be described with reference to the drawings. In the following description of the embodiments and the drawings, the same reference numerals indicate the same or corresponding parts.

### First Embodiment

### *** Description of Configuration ***

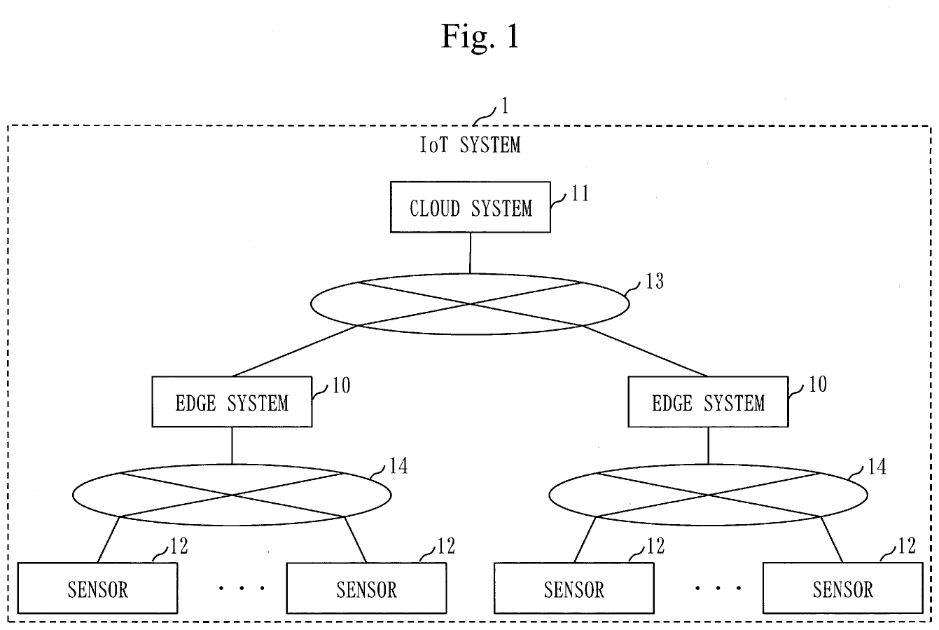

FIG. 1 illustrates a configuration example of an IoT system 1 according to the present embodiment.

In the present embodiment, a cloud system 11 is connected to the Internet 13. Further, a plurality of edge systems 10 are connected to the Internet 13 and intranets 14. Further, a plurality of sensors 12 are connected to the intranets 14.

In the present embodiment, instead of the cloud system 11, each edge system 10 responds to a semantic query from an application. A computational resource and a storage capacity of each edge system 10 are less than a computational resource and a storage capacity of the cloud system 11. However, the edge system 10 can appropriately respond to the semantic query from the application by a process which will be described below. As a result, it is possible to reduce a load concentration on the cloud system 11 and solve a communication delay.

Note that, operation performed by the edge system 10 is equivalent to an information processing method and an information processing program.

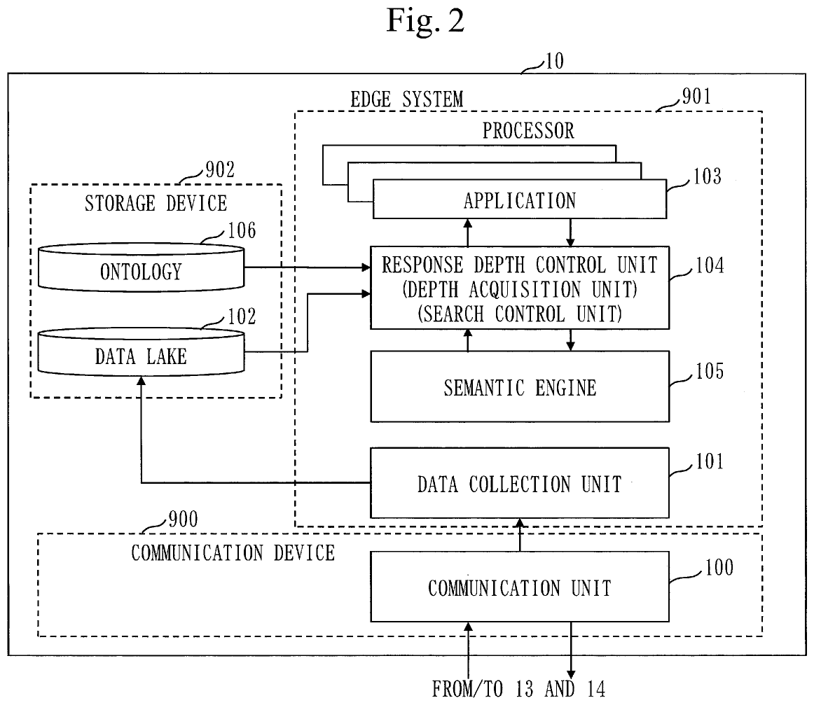

FIG. 2 illustrates a functional configuration example of the edge system 10.

The edge system 10 collects via the intranet 14, data measured by the sensor 12 or processed data after the sensor 12 performing a statistical process or the like. Further, the edge system 10 accesses the cloud system 11 via the Internet 13 as necessary, and accumulates the data in the cloud system 11. Further, the edge system 10 can also ask the cloud system 11 for performing a part of the process.

Hereinafter, the data measured by the sensor 12 or the processed data after the sensor 12 performing the statistical process or the like is collectively referred to as measurement data.

The edge system 10 is a computer having a communication device 900, a processor 901, and a storage device 902 as pieces of hardware.

Further, the edge system 10 has a communication unit 100, a data collection unit 101, a data lake 102, applications 103, a response depth control unit 104, a semantic engine 105, and ontology 106 as functional configurations.

The communication unit 100 receives the measurement data from the sensor 12.

The data collection unit 101 adds to the measurement data, metadata such as collection time. Further, if necessary, the data collection unit 101 implements a statistical process or normalization on the measurement data. Then, the data collection unit 101 saves in the data lake 102, the measurement data (or measurement data after the statistical process or the normalization) received by the communication unit 100.

The application 103 outputs application metadata including a query and response depth to the response depth control unit 104.

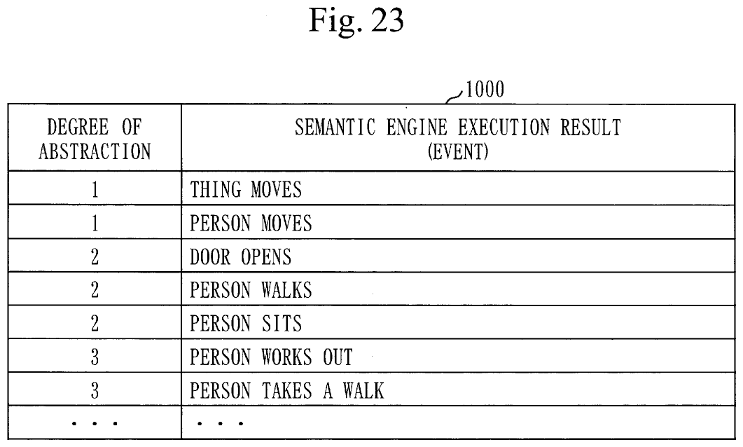

Here, the response depth is a parameter for obtaining a result requested by the application. That is, the response depth is a request for depth (hereinafter, also referred to as an execution depth) of a search by the semantic engine 105. For example, the execution depth is the number of times (the number of recursions) the semantic engine 105 is executed. That is, the application 103 can specify a request for the number of recursions as the response depth. Further, the execution depth may be depth in a parent-child relationship of ontology (the number of edges from a node to a root node when the ontology is a tree constitution). The depth in the parent-child relationship is expressed, for example, as a degree of abstraction prescribed in a depth specifying table 1000 illustrated in FIG. 23. That is, the application 103 can specify as the response depth, the request for a level (1, 2, 3, or the like) of the degree of the abstraction illustrated in FIG. 23.

The response depth control unit 104 acquires the application metadata including the query and the response depth.

Further, the response depth control unit 104 asks the semantic engine 105 for search. Further, the response depth control unit 104 causes the semantic engine 105 to repeat the search until the depth of the search by the semantic engine 105 reaches the response depth. For example, the response depth control unit 104 adjusts the number of times the semantic engine 105 is executed.

The response depth control unit 104 is equivalent to a depth acquisition unit and a search control unit. Further, a process performed by the response depth control unit 104 is equivalent to a depth acquisition process and a search control process.

Specifically, the semantic engine 105 is an inference device or the like using machine learning and/or an RDF (Resource Description Framework). The semantic engine 105 may use only a part of the machine learning and the RDF. Further, the semantic engine 105 may also use the machine learning and the RDF in parallel or in series.

The data collection unit 101, the application 103, the response depth control unit 104, and the semantic engine 105 are realized by a program. The program that realizes the data collection unit 101, the application 103, the response depth control unit 104, and the semantic engine 105 is executed by the processor 901.

Further, the data collection unit 101, the response depth control unit 104, and the semantic engine 105 may be realized by dedicated hardware.

FIG. 1 illustrates an example in which the data collection unit 101, the application 103, the response depth control unit 104, and the semantic engine 105 are realized by the program, and the processor 901 executes the program.

The communication unit 100 is realized by the communication device 900.

The data lake 102 and the ontology 106 are provided in the storage device 902 (including a memory and an auxiliary storage device). Note that, the data lake 102 and the ontology 106 may be realized by dedicated hardware.

*** Description of Operation ***

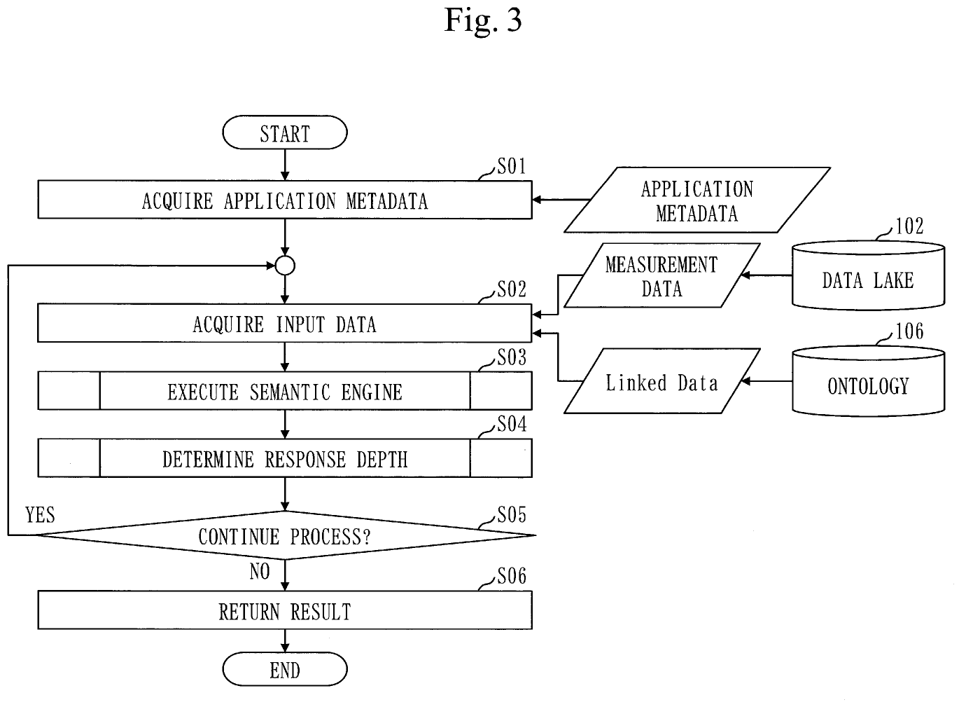

FIG. 3 illustrates an operation example of the edge system 10 according to the present embodiment.

First, the response depth control unit 104 acquires the application metadata including the query and the response depth from the application 103 (step S01).

Next, the response depth control unit 104 acquires as input data, the measurement data required for the machine learning and Linked Data required for the inference device from the data lake 102 and the ontology 106 (step S02).

Then, the response depth control unit 104 outputs the input data to the semantic engine 105.

Next, the semantic engine 105 performs the search according to the query included in the application metadata (step S03).

Note that, the semantic engine 105 may perform the search by using the application metadata and the metadata of the measurement data saved in the data lake 102. Specifically, the semantic engine 105 can narrow down the data according to a time period, an installation location of the sensor, and the like. Further, the semantic engine 105 can recursively perform the search by using a last execution result.

When the RDF is used in the semantic engine 105, the response depth control unit 104 may read the Linked Data in advance at a time of starting the edge system 10 in order to reduce the load from loading the Linked Data.

After the execution of the semantic engine 105, the response depth control unit 104 performs a response depth determination process (step S04). That is, the response depth control unit 104 determines whether or not the depth (the number of recursions and the degree of the abstraction) of the search by the semantic engine 105 reaches the response depth. As a result of the response depth determination process, when the process is continued (YES in step S05), processes on and after the input data acquisition (S02) are repeated. On the other hand, when the process is not continued (NO in step S05), the response depth control unit 104 returns an execution result of the semantic engine 105 to the application 103 (step S06).

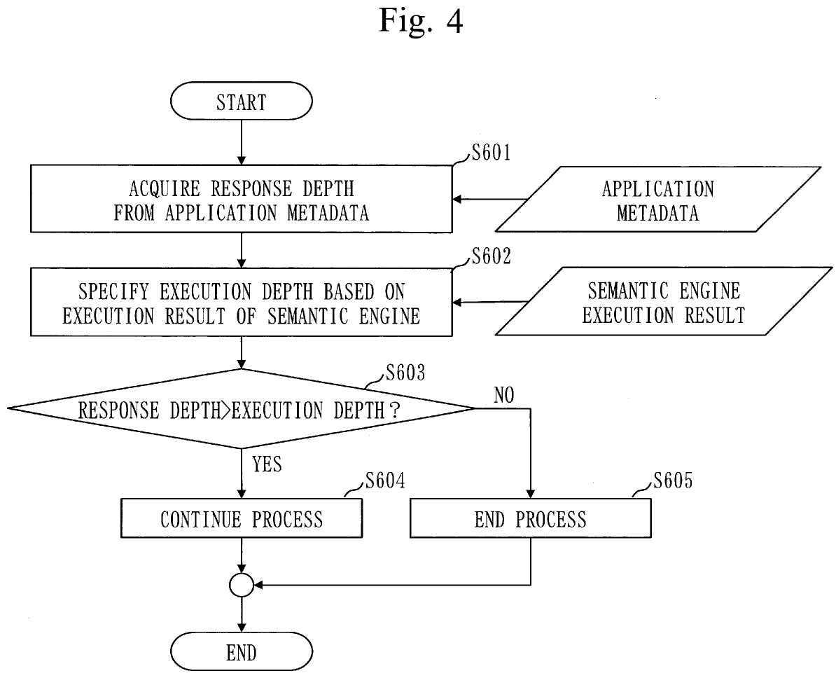

FIG. 4 illustrates details of the response depth determination process (step S04 in FIG. 3).

The response depth control unit 104 acquires the response depth requested by the application from the application metadata (step S601).

Next, the response depth control unit 104 specifies the execution depth based on the execution result of the semantic engine 105 or the depth in the parent-child relationship of the ontology (step S602).

As described above, the execution depth is, for example, the number of recursions by the semantic engine 105 or the degree of the abstraction exemplified in FIG. 23.

When the execution depth is less than the response depth (YES in step S603), the response depth control unit 104 decides to continue the process of the semantic engine 105 (step S604).

When the execution depth is equal to or more than the response depth (NO in step S603), the response depth control unit 104 decides to end the process of the semantic engine 105 (step S605).

Note that, even if there are a plurality of execution results of the semantic engine 105, the response depth determination process (step S04 in FIG. 3) is individually implemented for each of the execution results.

### Description of Effect of Embodiment

As described above, in the present embodiment, the response depth control unit 104 causes the semantic engine 105 to repeat the search until the execution depth of the semantic engine 105 reaches the response depth. Therefore, even the edge system 10 whose computation resource and storage capacity are limited can appropriately respond to the query from the application 103 as with the cloud system 11. That is, in the present embodiment, it is possible to respond at an arbitrary response depth (the degree of abstraction) according to the request from the application 103.

Further, in the present embodiment, most of functions of the IoT system operate on the edge system 10 on the intranet 14. Therefore, according to the present embodiment, the functions of the IoT system can be provided to the application 103 even in a situation where the cloud system 11 is unusable because the Internet 13 is unusable (improvement of availability).

Further, in the present embodiment, it is unnecessary to construct a dedicated IoT system for each application 103 (a reduction of a cost and efficiency improvement of development).

Note that, although a condition for ending a recursion process is determined based on the number of recursions or the degree of the abstraction in the present embodiment, the condition for ending the recursion process may be determined based on the total number of results obtained in a course of a recursion execution. Further, the condition for ending the recursion process may be determined based on whether or not n pieces (n is a natural number) from the top in a scoring result, which will be described in a seventh embodiment, are obtained. Note that, the application metadata describes which condition is used for ending the recursion process.

### Second Embodiment

In the present embodiment, a configuration that enables scaling out or scaling down of the edge system will be described.

In the present embodiment, differences from the first embodiment will be mainly described.

Note that, matters not described below are the same as those in the first embodiment.

*** Description of Configuration ***

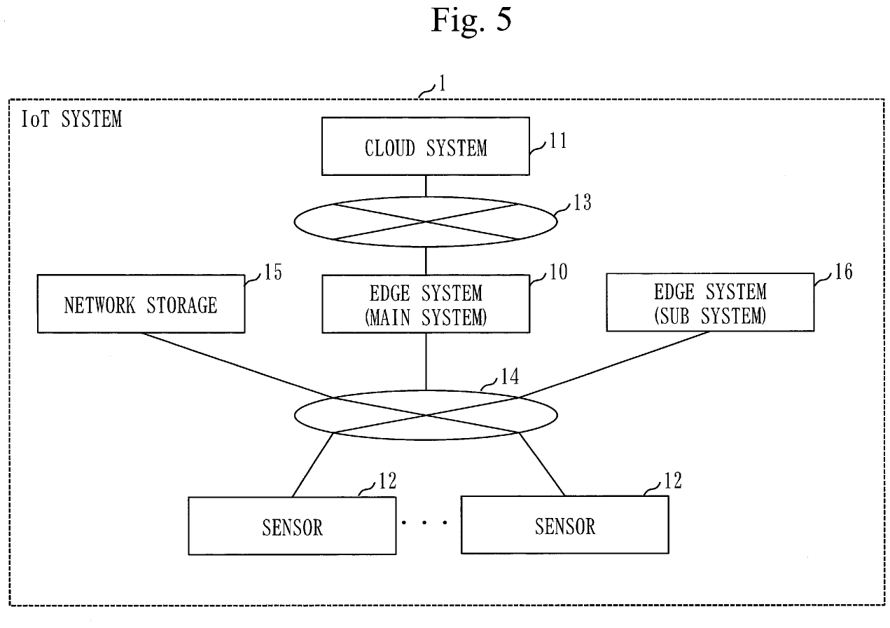

FIG. 5 illustrates a configuration example of the IoT system 1 according to the present embodiment.

In FIG. 5, a master-slave model that is easy to be realized is adopted.

In the present embodiment, a network storage 15 and an edge system (sub system) 16 are newly installed on the intranet 14. Further, in the present embodiment, it is noted as an edge system (main system).

The network storage 15 is not necessarily required. However, storing in the network storage 15, the measurement data commonly used by the edge system (main system) 10 and the edge system (sub system) 16, facilitates a management of the measurement data.

Note that, there may be a plurality of edge systems (sub systems) 16.

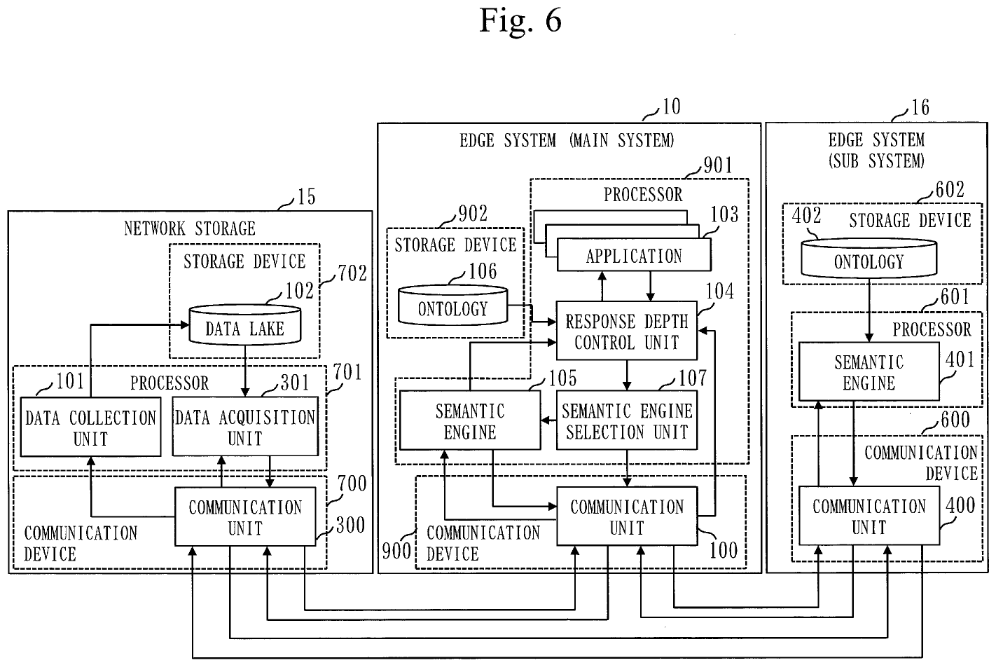

FIG. 6 illustrates functional configuration examples of the network storage 15, the edge system (main system) 10, and the edge system (sub system) 16.

In the present embodiment, the data collection unit 101 and the data lake 102 described in the first embodiment are installed in the network storage 15 instead of the edge system (main system) 10. On the other hand, a semantic engine selection unit 107 is added to the edge system (main system) 10.

The semantic engine selection unit 107 selects the semantic engine according to a domain of the query from the application or a query at a time of execution of the recursion. More specifically, the semantic engine selection unit 107 selects a semantic engine which is caused to perform the search, from the semantic engine 105 included in the edge system (main system) 10 and a semantic engine 401 included in the edge system (sub system) 16. Then, the semantic engine selection unit 107 causes the selected semantic engine to perform the search.

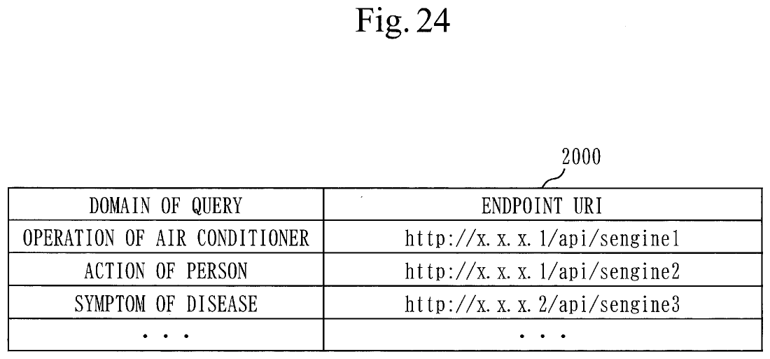

The semantic engine selection unit 107 selects one of the semantic engine 105 of the edge system (main system) 10 and the semantic engine 401 of the edge system (sub system) 16, for example, based on an endpoint specifying table 2000 illustrated in FIG. 24. In FIG. 24, an endpoint URI (Uniform Resource Identifier) of the semantic engine to be selected is defined for each domain (a type of the search) of the query. The semantic engine selection unit 107 selects the semantic engine corresponding to the domain of the query from the application 103 with reference to the endpoint specifying table 2000 in FIG. 24. Note that, the endpoint specifying table 2000 in FIG. 24 is equivalent to selection criterion information.

The semantic engine selection unit 107 is, for example, realized by a program and executed by the processor 901. Further, the semantic engine selection unit 107 may be realized by dedicated hardware.

In the network storage 15, the data collection unit 101 collects the measurement data of the sensor 12 via the intranet 14 and a communication unit 300. The data collection unit 101 stores the collected measurement data in the data lake 102 as with the first embodiment.

A data acquisition unit 301 retrieves the data from the data lake 102 in response to a request from the edge system (main system) 10 or the edge system (sub system) 16. Further, the data acquisition unit 301 transmits the retrieved data to the edge system (main system) 10 or the edge system (sub system) 16.

The data collection unit 101 and the data acquisition unit 301 are realized by a program. The program that realizes the data collection unit 101 and the data acquisition unit 301 is executed by a processor 701.

Further, the data collection unit 101 and the data acquisition unit 301 may be realized by dedicated hardware.

FIG. 6 illustrates an example in which the data collection unit 101 and the data acquisition unit 301 are realized by the program, and the processor 701 executes the program.

The communication unit 300 is realized by a communication device 700.

The data lake 102 is provided in a storage device 702 (including a memory and an auxiliary storage device). Note that, the data lake 102 may be realized by dedicated hardware.

The edge system (sub system) 16 executes the semantic engine 401 based on the query from the edge system (main system) 10. Then, the edge system (sub system) 16 returns the execution result of the semantic engine 401 to the edge system (main system) 10. Further, the edge system (sub system) 16 acquires input data required for executing the semantic engine 401 from the network storage 15 or ontology 402 as necessary.

A communication unit 400 is realized by a communication device 600.

The semantic engine 401 is executed by a processor 601. The semantic engine 401 may be realized by dedicated hardware.

FIG. 6 illustrates an example in which the semantic engine 401 is executed by the processor 601.

The ontology 402 is provided in a storage device 602 (including a memory and an auxiliary storage device). Note that, the ontology 402 may be realized by dedicated hardware.

*** Description of Operation ***

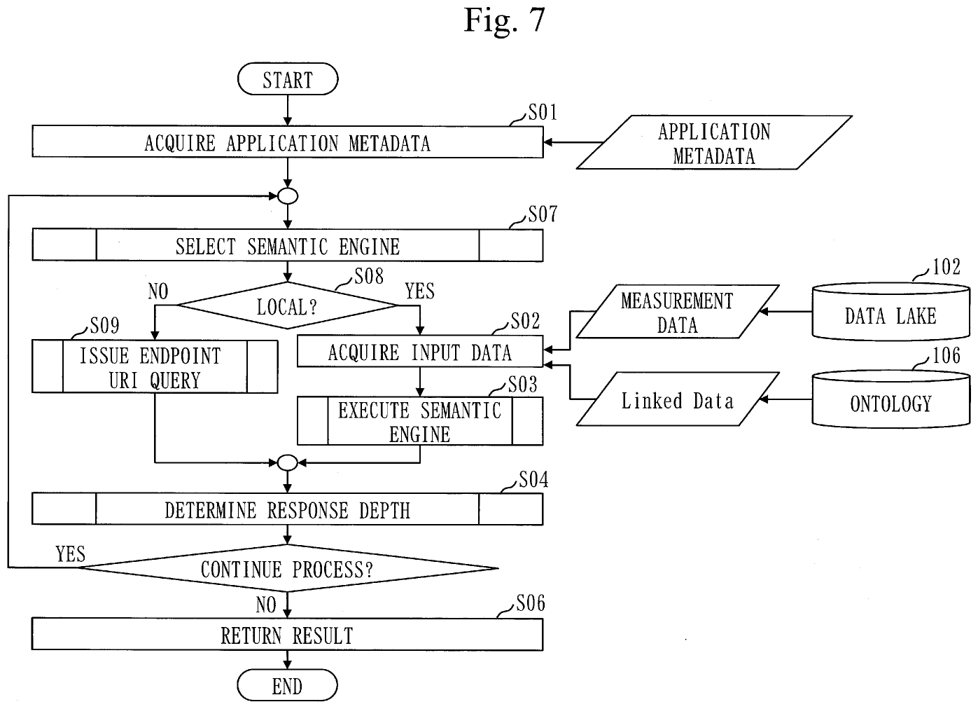

FIG. 7 illustrates an operation example of the edge system (main system) 10 according to the present embodiment.

In the following, only differences from the first embodiment will be described.

Since step S01 is the same as that in the first embodiment, descriptions will be omitted.

Next, the semantic engine selection unit 107 selects the semantic engine (step S07).

When the semantic engine selection unit 107 selects the semantic engine 105 (the endpoint URI of the semantic engine 105) in the edge system (main system) 10 (YES in step S08), the same process as that in the first embodiment is performed (steps S02 to S06).

On the other hand, when the semantic engine selection unit 107 selects the semantic engine 401 (the endpoint URI of the semantic engine 401) of the edge system (sub system) 16 (NO in step S08), the semantic engine selection unit 107 issues a query to the endpoint URI of the edge system (sub system) 16 (step S09). Then, the semantic engine selection unit 107 acquires the execution result from the edge system (sub system) 16.

Note that, although FIG. 7 does not illustrate, if the semantic engine selection unit 107 cannot specify the endpoint URI of the semantic engine, the semantic engine selection unit 107 skips the query without executing the query. Alternatively, the semantic engine selection unit 107 returns an error notification to the application 103.

Processes after acquiring the execution result of the semantic engine are the same as those in the first embodiment (steps S04 to S06).

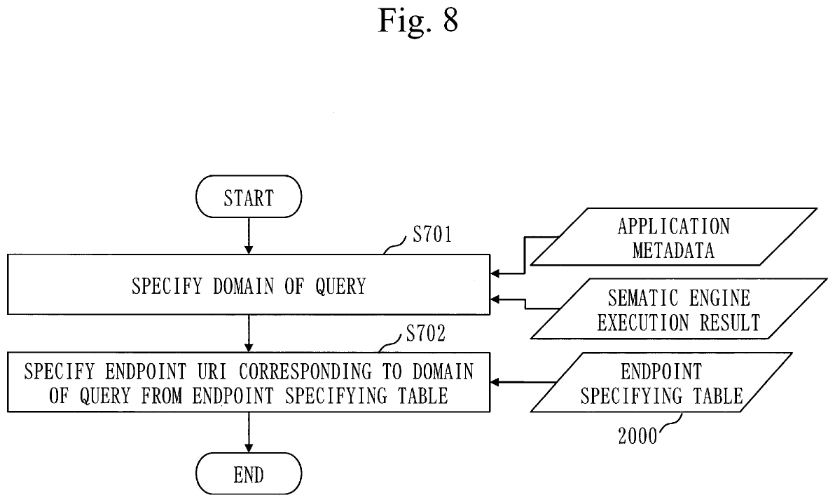

FIG. 8 illustrates details of the semantic engine selection process (step S07) in FIG. 7.

The semantic engine selection unit 107 generates a query to be executed this time from the application metadata or the execution result of the semantic engine. Then, the semantic engine selection unit 107 specifies the domain of the query (step S701).

Next, the semantic engine selection unit 107 specifies the endpoint URI of the semantic engine corresponding to the specified domain of the query in the endpoint specifying table 2000 in FIG. 24 (step S702).

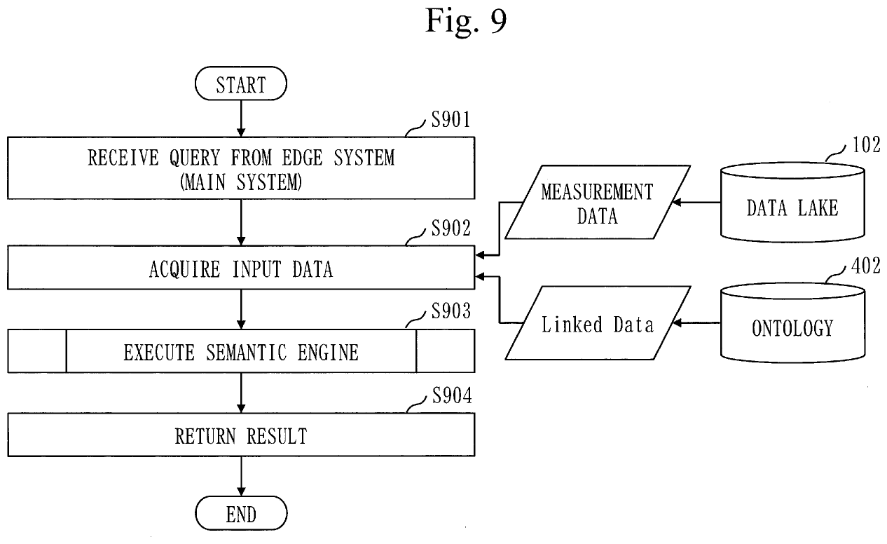

FIG. 9 illustrates an operation example of the edge system (sub system) 16.

More specifically, FIG. 9 illustrates a process procedure for the query issued in step S09 in FIG. 7.

First, the semantic engine 401 receives the query from the edge system (main system) 10 via the communication unit 400 (S901).

Next, the semantic engine 401 acquires the required input data (step S902).

When the measurement data is required, the semantic engine 401 inquires the data acquisition unit 301 of the network storage 15 and obtains the measurement data. Further, when the Linked Data for RDF execution is required, the semantic engine 401 loads the Linked Data from the ontology 402.

Then, the semantic engine 401 executes the search by using the input data (step S903).

Then, the semantic engine 401 returns the execution result to the edge system (main system) 10 via the communication unit 400 (step S904).

Besides, at a time of scaling out, an edge system (sub system) equivalent to the edge system (sub system) 16 is added on the intranet 14. Subsequently, the semantic engine selection unit 107 adds to the endpoint specifying table 2000, a domain of the query which the newly added edge system (sub system) handles, and the endpoint URI. On the other hand, at a time of scaling down, the edge system (sub system) which is subject to deletion is removed from the intranet 14. The semantic engine selection unit 107 deletes from the endpoint specifying table 2000, a domain of the query which the removed edge system (sub system) handles, and the endpoint URI.

Besides, in the present embodiment, the descriptions have been made by taking the master-slave model type as an example. However, a model using a servant, such as pure P2P, in which functions of the edge systems are symmetrical may be used.

Further, in the present embodiment, an example has been described in which the edge system (sub system) 16 installed on the intranet 14 is used. Instead, the edge system (sub system) 16 may be installed on the Internet 13, and the edge system (sub system) 16 installed on the Internet 13 may be used.

### Description of Effect of Embodiment

As described above, according to the present embodiment, it is easy to scale out and scale down. That is, according to the present embodiment, processing ability can be easily enhanced, and the processing ability can be easily lowered.

Further, according to the present embodiment, by preparing a plurality of edge systems (sub systems) having a same function, redundancy becomes realizable, and availability is improved.

### Third Embodiment

In the present embodiment, a configuration in which a semantic engine of the cloud system is selected will be described.

In the present embodiment, differences from the second embodiment will be mainly described.

Note that, matters not described below are the same as those in the second embodiment.

*** Description of Configuration ***

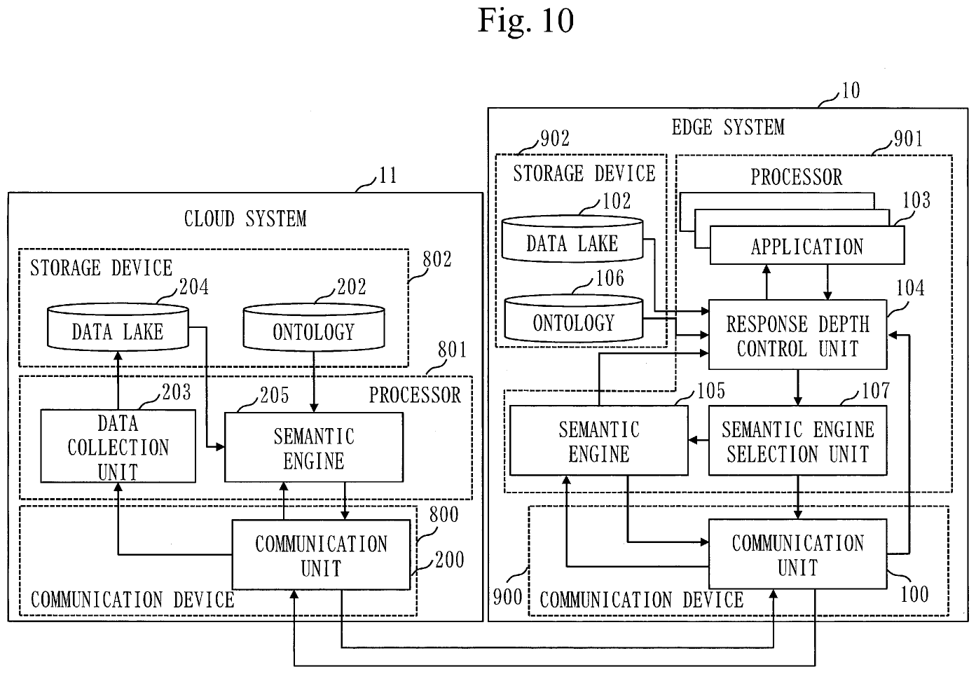

FIG. 10 illustrates functional configuration examples of the edge system 10 and the cloud system 11 according to the present embodiment.

The functional configuration of the edge system 10 is the same as that in the first embodiment.

In the cloud system 11, a data collection unit 203 collects the measurement data of the sensor 12 from the edge system 10. Then, the data collection unit 203 stores the collected measurement data in a data lake 204.

The edge system 10 can select the measurement data to be transmitted to the cloud system 11. Further, the edge system 10 may be anonymized by converting the measurement data to be transmitted to the cloud system 11 into a statistical value, and so on.

The data collection unit 203 and a semantic engine 205 are executed by a processor 801.

Further, the data collection unit 203 and the semantic engine 205 may be executed by dedicated hardware.

FIG. 10 illustrates an example in which the data collection unit 203 and the semantic engine 205 are executed by the processor 801.

A communication unit 200 is realized by a communication device 800. The data lake 204 and ontology 202 are provided in a storage device 802 (including a memory and an auxiliary storage device). The data lake 204 and the ontology 202 may be realized by dedicated hardware.

*** Description of Operation ***

Since processes of the edge system 10 according to the present embodiment are almost the same as those of the edge system (main system) 10 in the second embodiment, only differences will be described.

In order to use the semantic engine 205 of the cloud system 11, the semantic engine selection unit 107 adds to the endpoint specifying table 2000 in FIG. 24, the domain of the query which the semantic engine 205 handles, and the endpoint URI.

Then, the semantic engine selection unit 107 selects one of the semantic engine 105 of the edge system 10 and the semantic engine 205 of the cloud system 11 based on the endpoint specifying table 2000.

In the cloud system 11, upon receiving the query from the edge system 10, the semantic engine 205 acquires the input data required for executing the search.

When the measurement data is required, the semantic engine 205 obtains the measurement data from the data lake 204.

When the Linked Data for the RDF execution is required, the semantic engine 205 loads the Linked Data from the ontology 202.

Then, the semantic engine 205 executes the search by using the input data.

Then, the semantic engine 205 returns the execution result to the edge system 10 via the communication unit 200.

### Description of Effect of Embodiment

According to the present embodiment, by causing a cloud system whose resources are abundant to handle a part of a search process of the semantic engine, it is possible to expand response variations to the application.

Further, according to the present embodiment, since it is possible to determine whether or not the cloud system is used, according to the request from the application, it is possible to avoid the load concentration on the cloud system.

### Fourth Embodiment

In the present embodiment, a configuration will be described, which removes a result whose relevance to the query from the application is low from the execution result of the semantic engine, and enables accuracy of the execution result to improve.

In the present embodiment, differences from the first embodiment will be mainly described.

Note that, matters not described below are the same as those in the first embodiment.

*** Description of Configuration ***

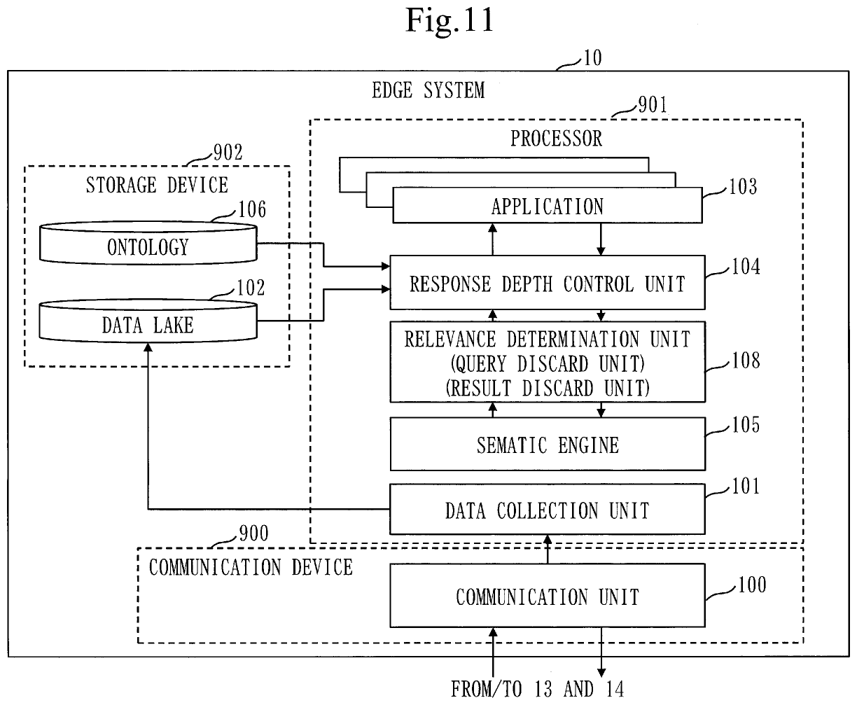

FIG. 11 is a functional configuration example of the edge system 10 according to the present embodiment.

Only differences from the first embodiment will be described.

In FIG. 11, a relevance determination unit 108 is added between the semantic engine 105 and the response depth control unit 104.

The relevance determination unit 108 acquires the query which is from the response depth control unit 104 to the semantic engine 105. Then, the relevance determination unit 108 predicts the execution result of the semantic engine 105 for the acquired query. Then, the relevance determination unit 108 determines whether or not the predicted execution result matches the execution result required by the application 103. When the predicted execution result does not match the execution result required by the application 103, the relevance determination unit 108 discards the query.

Further, the relevance determination unit 108 acquires the execution results of the semantic engine 105. The relevance determination unit 108 compares the query from the application 103 with the execution result of the semantic engine 105. Then, the relevance determination unit 108 determines whether or not an execution result that does not match the query exists in the execution results of the semantic engine 105. When the execution result that does not match the query exists in the execution results of the semantic engine 105, the relevance determination unit 108 discards the execution result that does not match the query.

The relevance determination unit 108 is equivalent to a query discard unit and a result discard unit.

*** Description of Operation ***

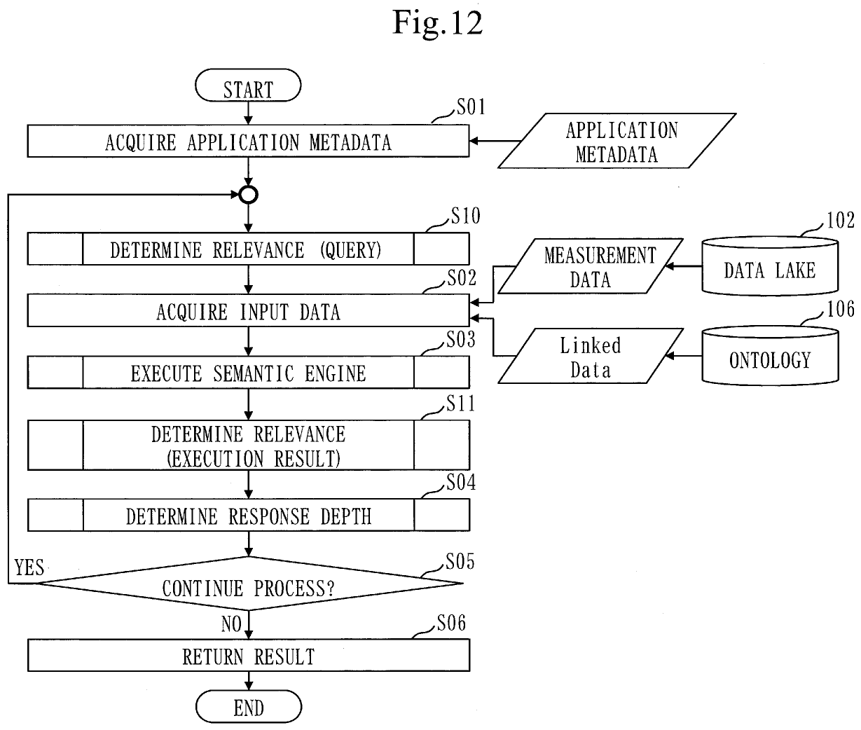

FIG. 12 illustrates an operation example of the edge system 10 according to the present embodiment.

Note that, in the following, only differences from the first embodiment will be described.

Since step S01 is the same as that in the first embodiment, descriptions will be omitted.

Next, the relevance determination unit 108 implements relevance determination on the query to the semantic engine 105 (step S10).

That is, the relevance determination unit 108 predicts the execution result of the semantic engine 105 for the query, and discards the query when the predicted execution result does not match the execution result required by the application 103.

Since steps S02 and S03 are the same as those in the first embodiment, descriptions will be omitted.

Next, the relevance determination unit 108 implements the relevance determination on the execution results of the semantic engine 105 (step S11).

That is, when an execution result that does not match the query exists in the execution results of the semantic engine 105, the relevance determination unit 108 discards the execution result that does not match the query.

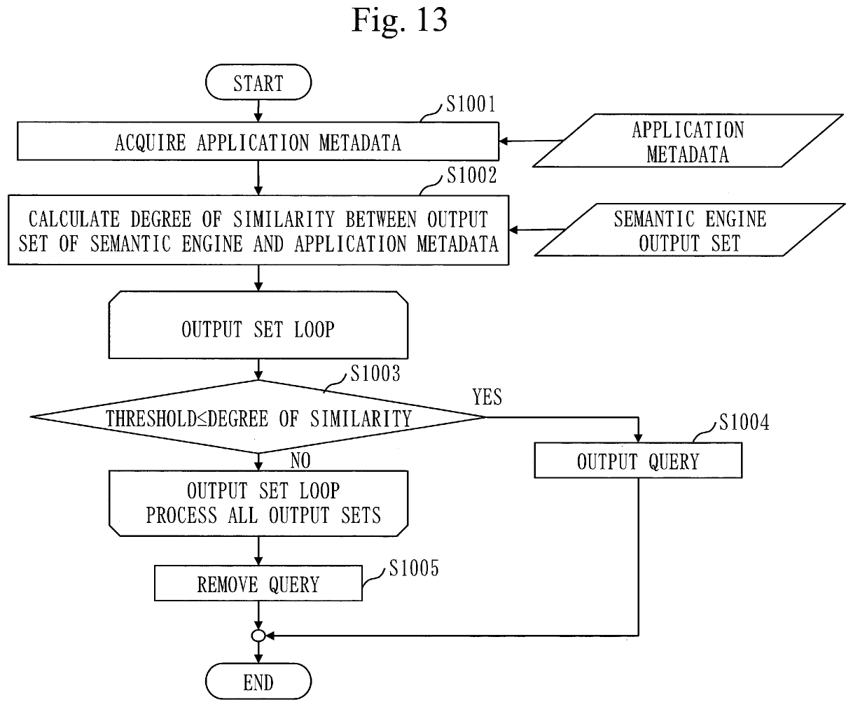

FIG. 13 illustrates details of a relevance determination process (query) (step S10 in FIG. 12).

The relevance determination unit 108 acquires the application metadata from the response depth control unit 104 (step S1001).

Next, the relevance determination unit 108 calculates a degree of similarity between a set of all answers (output set) output by the semantic engine 105 and the application metadata (step S1002).

That is, the relevance determination unit 108 predicts all the answers to be output by the semantic engine 105. Next, the relevance determination unit 108 calculates the degree of similarity between each of all the predicted answers and the application metadata.

The relevance determination unit 108 calculates the degree of similarity, for example, as follows.

Here, it is considered that “indoor action” is included in the application metadata as the query. It is assumed that “crossing a (indoor) corridor”, “taking a walk (outside)”, and “going up stairs” have been obtained as the output set of the semantic engine. The relevance determination unit 108 uses a Euclidean distance, a correlation function, a likelihood function, or the like as the degree of similarity. Here, it is assumed that the relevance determination unit 108 uses the likelihood function.

A likelihood function L is defined as follows.

If P(A|B=b) is a conditional probability of an occurrence of A in a case where B=b occurs, L(b|A)=∝P(A|B=b) is denoted (a is a proportional symbol).

A degree of similarity of “crossing a (indoor) corridor” is L(indoor action|crossing a (indoor) corridor)>0. That is, an event of “crossing a (indoor) corridor” is plausible as the indoor action.

Similarly, L(indoor action|taking a walk (outside))=0 and L(indoor action|going up stairs)=½. Since an event of “going up stairs” can occur both indoors and outdoors, the degree of similarity is ½.

Next, the relevance determination unit 108 compares the degree of similarity and a threshold value for all the output sets (step S1003).

If there exists even one output whose degree of similarity is equal to or more than the threshold value (YES in step S1003), the relevance determination unit 108 outputs the query to the semantic engine 105 (step S1004).

On the other hand, when all of the degrees of similarity of the output sets are less than the threshold value (NO in step S1003), the relevance determination unit 108 does not output the query to the semantic engine 105 and removes the query (step S1005). At this time, the relevance determination unit 108 notifies the response depth control unit 104 that a valid response does not exist.

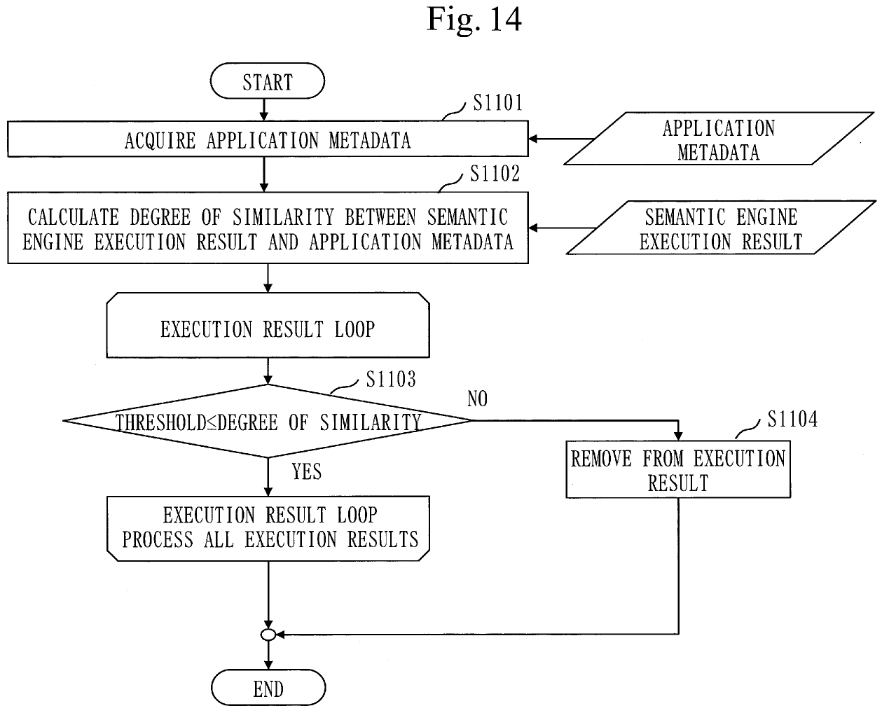

FIG. 14 illustrates details of a relevance determination process (execution result) (step S11 in FIG. 12).

The relevance determination unit 108 acquires the application metadata from the response depth control unit 104 (step S1101).

Next, the relevance determination unit 108 calculates a degree of similarity between the execution result of the semantic engine 105 and the application metadata (step S1102).

The relevance determination unit 108 calculates the degree of similarity according to the same calculation method as the calculation method in step S1002 in FIG. 13.

Next, the relevance determination unit 108 compares the degree of similarity and the threshold value for all the execution results (step S1103).

When the degree of similarity is less than the threshold value (NO in step S1103), the relevance determination unit 108 removes a corresponding semantic engine execution result (step S1104).

On the other hand, if the degree of similarity is equal to or more than the threshold value (YES in step S1103), the relevance determination unit 108 outputs the execution result to the response depth control unit 104.

### Description of Effect of Embodiment

According to the present embodiment, it is possible to reduce resource consumption by suppressing an unnecessary recursion process.

Further, according to the present embodiment, noise is reduced in the response to the application.

### Fifth Embodiment

In the present embodiment, a configuration will be described in which the execution result of the semantic engine is expanded by a thesaurus (a synonym, a related word, and an associative word). The semantic engine can increase variations of the execution results by recursively executing the search using the expanded execution result.

In the present embodiment, differences from the first embodiment will be mainly described.

Note that, matters not described below are the same as those in the first embodiment.

*** Description of Configuration ***

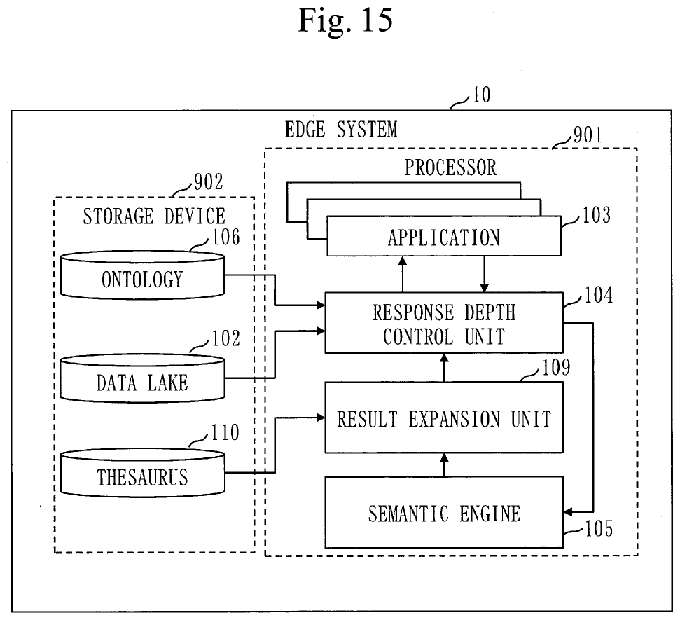

FIG. 15 illustrates a functional configuration example of the edge system 10 according to the present embodiment.

Only differences from the first embodiment will be described.

In FIG. 15, a result expansion unit 109 is added between the semantic engine 105 and the response depth control unit 104.

The result expansion unit 109 acquires the execution result of the semantic engine 105. Then, the result expansion unit 109 expands the execution result of the semantic engine 105 by using a thesaurus 110. The result expansion unit 109 returns the expanded execution result to the response depth control unit 104.

*** Description of Operation ***

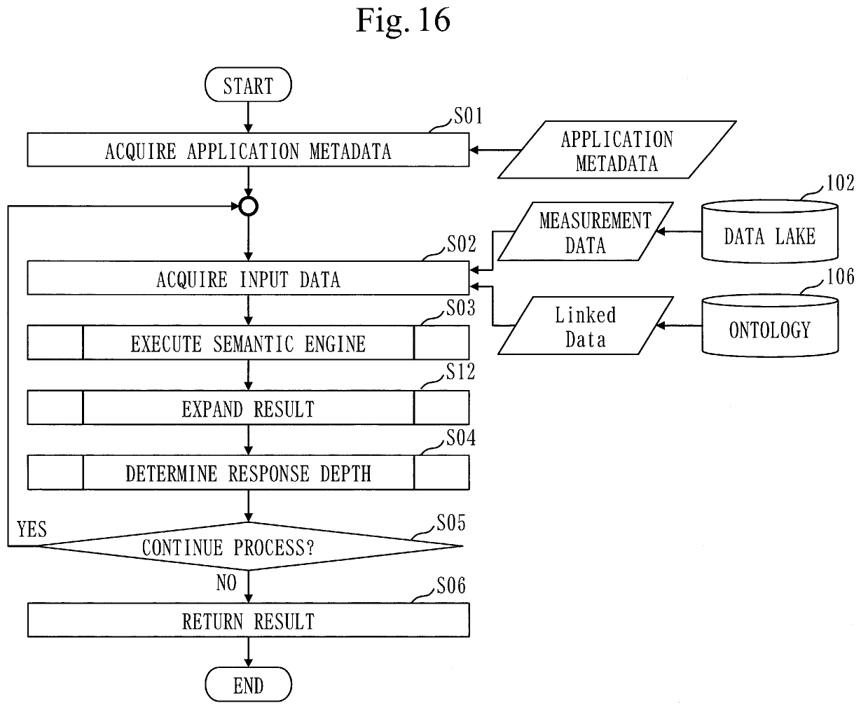

FIG. 16 illustrates an operation example of the edge system 10 according to the present embodiment.

Note that, in the following, only differences from the first embodiment will be described.

Since steps S01 to S03 are the same as those in the first embodiment, descriptions will be omitted.

Next, the result expansion unit 109 expands the execution result of the semantic engine 105 (step S12).

As a result, variations of inputs to the semantic engine 105 at a time of performing the recursion execution increase.

Since steps S04 to S06 are the same as those in the first embodiment, descriptions will be omitted.

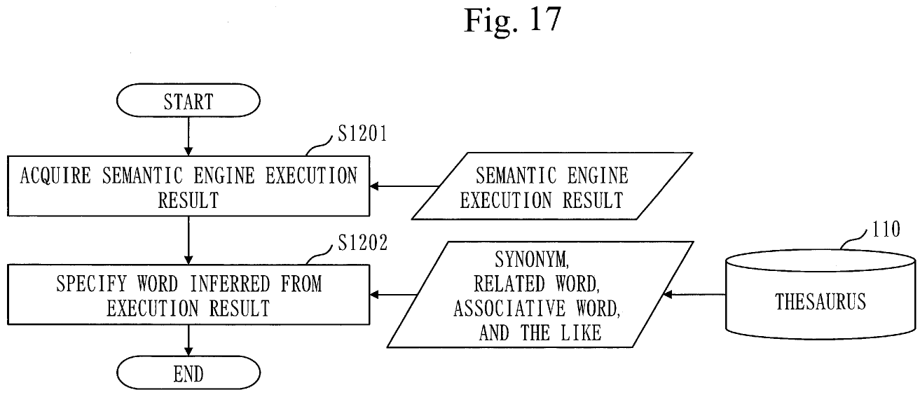

FIG. 17 illustrates details of a result expansion process (step S12 in FIG. 16).

The result expansion unit 109 acquires the execution result of the semantic engine 105 (step S1201).

Next, the result expansion unit 109 specifies a synonym, a related word, an associative word, and the like inferred from the execution result by using the thesaurus 110 (step S1202).

Then, the result expansion unit 109 outputs to the response depth control unit 104, the execution result of the semantic engine 105 and the word specified in step S1202.

### Description of Effect of Embodiment

According to the present embodiment, the accuracy of the result which is replied to the application is improved by preventing an oversight in inference due to inconsistency in words.

### Sixth Embodiment

In the present embodiment, a configuration will be described in which the ontology (Linked Data) of the RDF and model data of the machine learning used by the semantic engine of the edge system are acquired from the cloud system. By acquiring the ontology (Linked Data) and the model data from the cloud system, it is possible to dynamically control behavior of the semantic engine.

In the present embodiment, differences from the first embodiment will be mainly described.

Note that, matters not described below are the same as those in the first embodiment.

*** Description of Configuration ***

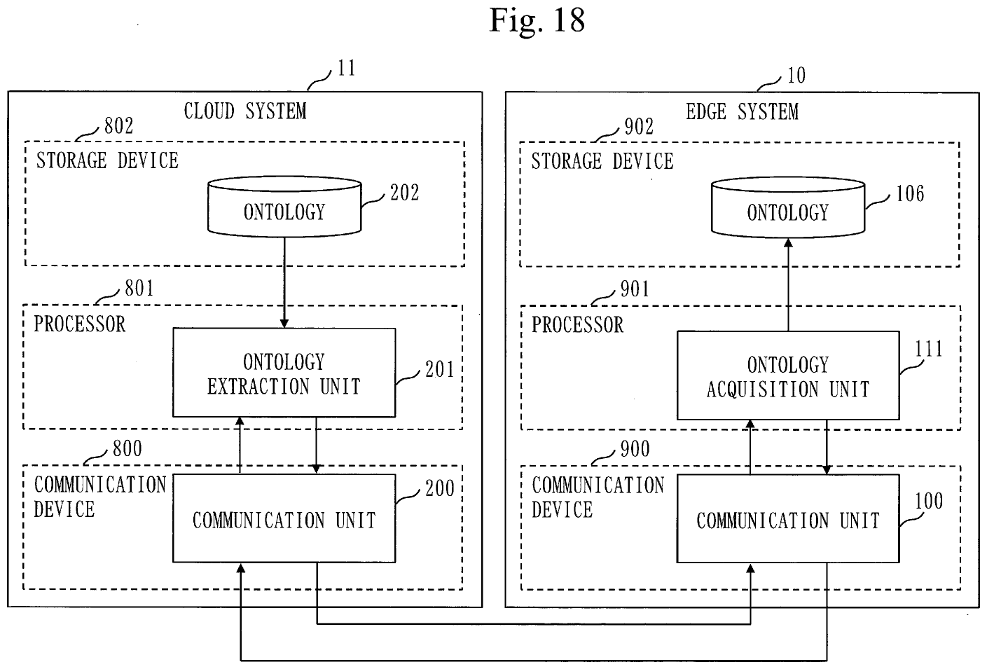

FIG. 18 illustrates functional configuration examples of the edge system 10 and the cloud system 11 according to the present embodiment.

Note that, FIG. 18 illustrates only configurations related to acquisition and extraction of the ontology (Linked Data) and the model data of the machine learning.

That is, in the edge system 10 according to the present embodiment, an ontology acquisition unit 111 is added to the configuration of the first embodiment. Further, in the cloud system 11 according to the present embodiment, an ontology extraction unit 201 is added to the configuration of the third embodiment.

In the edge system 10, the ontology acquisition unit 111 acquires from the cloud system 11, at least one of the ontology (Linked Data) and the model data of the machine learning which are used by the semantic engine 105.

In the cloud system 11, the ontology extraction unit 201 extracts at least one of the ontology (Linked Data) and the model data of the machine learning which are used by the semantic engine 105 based on the request from the edge system 10. Then, the ontology extraction unit 201 transmits the extracted ontology (Linked Data) or/and model data to the edge system 10.

*** Description of Operation ***

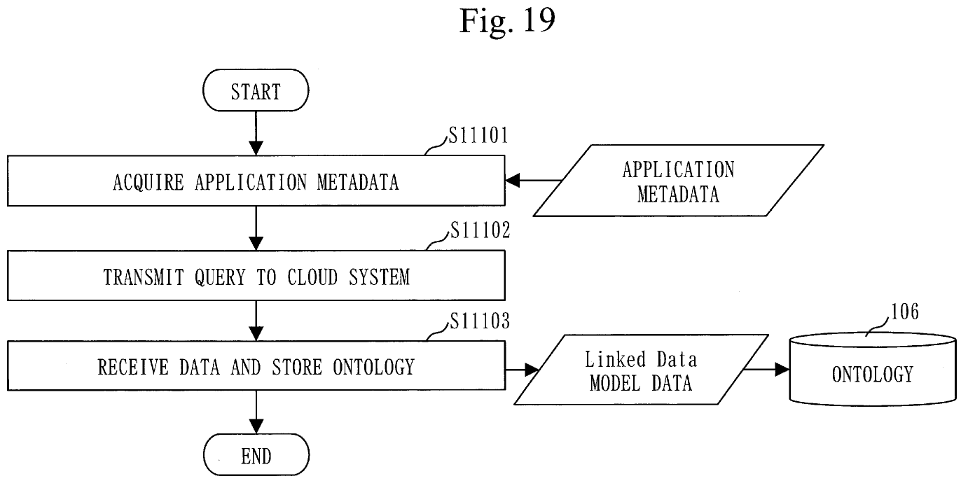

FIG. 19 illustrates an operation example of the edge system 10 according to the present embodiment.

Note that, in the following, an example will be described in which the ontology acquisition unit 111 receives the Linked Data and the model data, however, the ontology acquisition unit 111 may receive only one of the Linked Data and the model data. Further, the ontology acquisition unit 111 may receive data other than the Linked Data and the model data as long as the data is used by the semantic engine 105.

First, the ontology acquisition unit 111 acquires the application metadata (step S11101).

Next, the ontology acquisition unit 111 transmits to the cloud system 11, a query for acquiring the Linked Data and the model data (step S11102). The query includes the application metadata.

Next, the ontology acquisition unit 111 receives the Linked Data and the model data from the cloud system 11, and further, stores the received Linked Data and model data in the ontology 106 (step S11103).

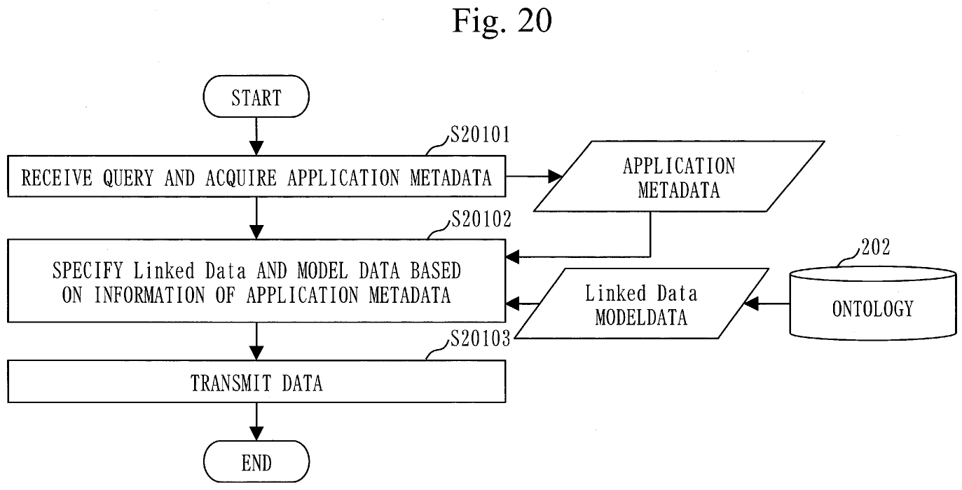

FIG. 20 illustrates an operation example of the cloud system 11 according to the present embodiment.

Note that, in the following, an example will be described in which the ontology extraction unit 201 extracts the Linked Data and the model data, however, the ontology extraction unit 201 may extract only one of the Linked Data and the model data. Further, the ontology extraction unit 201 may extract data other than the Linked Data and the model data as long as the data is used by the semantic engine 105.

First, the ontology extraction unit 201 receives the query from the edge system 10 and extracts the application metadata from the query (step S20101).

Next, the ontology extraction unit 201 extracts the Linked Data and the model data which meet a condition, from the ontology 202, based on information of the application metadata (step S20102).

Specifically, the ontology extraction unit 201 narrows down the Linked Data and the model data which meet the condition, based on a domain (for example, a human action, a type of disease, operation of a device, or the like) of the application or statistical information (a past usage record of another similar application, or the like). Note that, when the ontology extraction unit 201 extracts the Linked Data, the ontology extraction unit 201 may remove an unnecessary link from the Linked Data. At that time, the ontology extraction unit 201 may determine a necessity of the link by using the machine learning, the statistical information, or the like.

Next, the ontology extraction unit 201 returns the extracted Linked Data and model data to the edge system 10 (step S20103).

### Description of Effect of Embodiment

According to the present embodiment, it is possible to appropriately update the ontology of the edge system. Therefore, according to the present embodiment, it is possible to improve the accuracy of the execution result to be output to the application.

Further, according to the present embodiment, it is possible to centrally manage the ontology on the cloud system. Therefore, according to the present embodiment, it is possible to divert knowledge to a similar application on another edge system. As a result, it is possible to improve the accuracy of the execution result of the semantic engine from the beginning of running of the other edge system.

### Seventh Embodiment

In the present embodiment, a configuration will be described in which an order of priority is set in the execution results of the semantic engine. As a result, the application can recognize importance in the execution results.

In the present embodiment, differences from the first embodiment will be mainly described.

Note that, matters not described below are the same as those in the first embodiment.

*** Description of Configuration ***

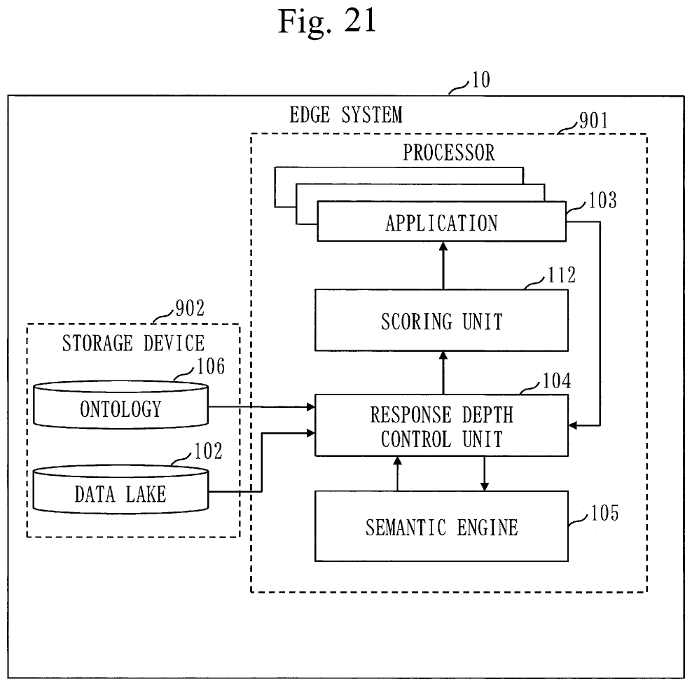

FIG. 21 illustrates a functional configuration example of the edge system 10 according to the present embodiment.

Only differences from the first embodiment will be described.

In FIG. 21, a scoring unit 112 is added between the response depth control unit 104 and the applications 103.

The scoring unit 112 sets the order of priority to the execution results of the semantic engine 105. More specifically, the scoring unit 112 sets the order of priority to the execution results of the semantic engine 105 based on progress in inference by the semantic engine 105.

Note that, FIG. 21 illustrates only a configuration necessary for explaining the scoring unit 112.

*** Description of Operation ***

Next, operation of the scoring unit 112 will be described.

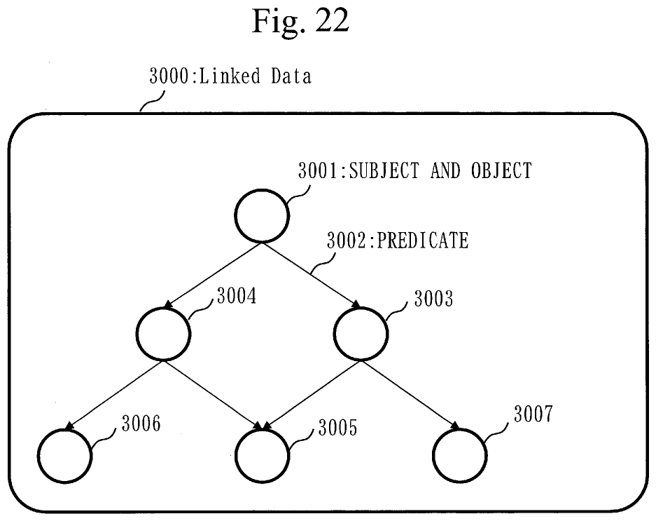

FIG. 22 is an example of the Linked Data used in the RDF of the semantic engine 105.

Linked Data 3000 is configured by nodes 3001, 3003, 3004, 3005, 3006, and 3007, each of which is at least one of a subject and an object, and directed graphs of predicates 3002 connecting the nodes.

In the first execution of the semantic engine 105, it is assumed that the node 3001 is inferred from the measurement data by the machine learning, and further, the nodes 3003 and 3004 are inferred by the RDF. In the second execution of the semantic engine 105, it is assumed that the nodes 3005, 3006, and 3007 are inferred. The scoring unit 112 records for each node, which node is passed at a time of the inference. In an example in FIG. 22, it is recorded that each of the nodes 3001, 3003, 3004, 3006, and 3007 is passed once, and the node 3005 is passed twice.

The scoring unit 112 treats the number of passages as a score. Then, the scoring unit 112 sets the order of priority to the execution results of the semantic engine 105 in a descending order of the score. Further, the scoring unit 112 gives a priority to an execution result which is high in the order of priority, and presents the execution result to the application. In the above example, the node 3005 is the highest in the order of priority. In the order of priority, the nodes 3001, 3003, 3004, 3006, and 3007 are all the same.

### Description of Effect of Embodiment

According to the present embodiment, since the scoring can be implemented by using information on the progress in the inference, it is possible to check the validity of the result.

Further, according to the present embodiment, the application can easily determine which execution result is important.

*** Description of Hardware Configuration ***

Finally, supplementary descriptions of a hardware configuration of the edge system 10 will be given.

The processor 901 is an IC (Integrated Circuit) that performs processing.

The processor 901 is a CPU (Central Processing Unit), a DSP (Digital Signal Processor), or the like.

The storage device 902 is a RAM (Random Access Memory), a ROM (Read Only Memory), a flash memory, an HDD (Hard Disk Drive), or the like.

The communication device 900 is an electronic circuit that executes communication processing of data.

The communication device 900 is, for example, a communication chip or an NIC (Network Interface Card).

Further, the storage device 902 also stores an OS (Operating System).

Then, at least a part of the OS is executed by the processor 901.

While executing at least the part of the OS, the processor 901 executes a program that realizes functions of the data collection unit 101, the application 103, the response depth control unit 104, the semantic engine 105, the semantic engine selection unit 107, the relevance determination unit 108, the result expansion unit 109, the ontology acquisition unit 111, and the scoring unit 112.

By the processor 901 executing the OS, task management, memory management, file management, communication control, and the like are performed.

Further, at least one of information, data, a signal value, and a variable value indicating a processing result of the data collection unit 101, the application 103, the response depth control unit 104, the semantic engine 105, the semantic engine selection unit 107, the relevance determination unit 108, the result expansion unit 109, the ontology acquisition unit 111, and the scoring unit 112 is stored in at least one of the storage device 902, and a register and a cache memory in the processor 901.

Further, the program that realizes the functions of the data collection unit 101, the application 103, the response depth control unit 104, the semantic engine 105, the semantic engine selection unit 107, the relevance determination unit 108, the result expansion unit 109, the ontology acquisition unit 111, and the scoring unit 112 may be stored in a portable recording medium such as a magnetic disk, a flexible disk, an optical disk, a compact disk, a Blu-ray (registered trademark) disk, or a DVD. Then, the portable recording medium storing the program that realizes the functions of the data collection unit 101, the application 103, the response depth control unit 104, the semantic engine 105, the semantic engine selection unit 107, the relevance determination unit 108, the result expansion unit 109, the ontology acquisition unit 111, and the scoring unit 112 may be commercially distributed.

Further, “unit” of the data collection unit 101, the response depth control unit 104, the semantic engine selection unit 107, the relevance determination unit 108, the result expansion unit 109, the ontology acquisition unit 111, and the scoring unit 112 may be read as “circuit” or “step” or “procedure” or “process”.

Further, the edge system 10 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Besides, in the present specification, a superordinate concept of the processor and the processing circuit is referred to as “processing circuitry”.

That is, each of the processor and the processing circuit is a specific example of the “processing circuitry”.

### REFERENCE SIGNS LIST

1: IoT system, 10: edge system, 11: cloud system, 12: sensor, 13: Internet, 14: intranet, 15: network storage, 16: edge system (sub system), 100: communication unit, 101: data collection unit, 102: data lake, 103: application, 104: response depth control unit, 105: semantic engine, 106: ontology, 107: semantic engine selection unit, 108: relevance determination unit, 109: result expansion unit, 110: thesaurus, 111: ontology acquisition unit, 112: scoring unit, 200: communication unit, 201: ontology extraction unit, 202: ontology, 203: data collection unit, 204: data lake, 205: semantic engine, 300: communication unit, 301: data acquisition unit, 400: communication unit, 401: semantic engine, 402: ontology, 600: communication device, 601: processor, 602: storage device, 700: communication device, 701: processor, 702: storage device, 800: communication device, 801: processor, 802: storage device, 900: communication device, 901: processor, 902: storage device, 1000: depth specifying table, 2000: endpoint specifying table.

1. An edge system comprising:
a semantic engine; and
processing circuitry to acquire a query to the semantic engine, predict an execution result of the semantic engine for the query, determine whether or not a predicted execution result matches an execution result required by an issuer of the query, and when the predicted execution result does not match the execution result required by the issuer of the query, discard the query.

2. The edge system according to claim 1,
wherein the edge system corresponds to a horizontally integrated type IoT (Internet of Things) platform, and
wherein the processing circuitry
acquires response depth which is a request for depth of a search by the semantic engine, and
causes the semantic engine to repeat the search until the depth of the search by the semantic engine reaches the response depth.

3. The edge system according to claim 1,
wherein the processing circuitry selects one of the semantic engine and a sematic engine included in another system, and causes the selected semantic engine to perform a search.

4. The edge system according to claim 3,
wherein the processing circuitry selects one of the semantic engine and a semantic engine installed in another edge system.

5. The edge system according to claim 3,
wherein the processing circuitry selects one of the semantic engine and a sematic engine installed in a cloud system.

6. The edge system according to claim 3,
wherein the processing circuitry refers to selection criterion information indicating for a type of the search, a semantic engine to be selected and selects a semantic engine corresponding to a type of the search which is subject to execution.

7. The edge system according to claim 6,
wherein the processing circuitry updates the selection criterion information according to at least one of scaling out and scaling down of the another system.

8. The edge system according to claim 1,
wherein the processing circuitry acquires a query to the semantic engine and execution results of the semantic engine, compares the query with the execution results of the semantic engine, determines whether or not there exists an execution result which does not match the query in the execution results of the semantic engine, and when there exists the execution result which does not match the query in the execution results of the semantic engine, discards the execution result which does not match the query.

9. The edge system according to claim 1,
wherein the processing circuitry acquires an execution result of the semantic engine, and expands the execution result of the semantic engine by using a thesaurus.

10. The edge system according to claim 1,
wherein the processing circuitry acquires data to be used by the semantic engine.

11. The edge system according to claim 1,
wherein the processing circuitry sets an order of priority to execution results of the semantic engine.

12. The edge system according to claim 11,
wherein the processing circuitry sets the order of priority to the execution results of the semantic engine based on progress in inference by the semantic engine.

13. An information processing method by an edge system being a computer which includes a semantic engine, the information processing method comprising
acquiring a query to the semantic engine, predicting an execution result of the semantic engine for the query, determining whether or not a predicted execution result matches an execution result required by an issuer of the query, and when the predicted execution result does not match the execution result required by the issuer of the query, discarding the query.

14. A non-transitory computer readable medium storing an information processing program which causes an edge system being a computer which includes a semantic engine, to execute
a query discard process of acquiring a query to the semantic engine, predicting an execution result of the semantic engine for the query, determining whether or not a predicted execution result matches an execution result required by an issuer of the query, and when the predicted execution result does not match the execution result required by the issuer of the query, discarding the query.
